(19) United States
(12) Patent Application Publication
(10) Pub. No.: US 2017/0345318 A1
(43) Pub. Date: Nov. 30, 2017

(54) AIRCRAFT CONTROL SYSTEM

(71) Applicant: General Electric Company, Schenectady, NY (US)

(72) Inventors: So Young Kim, San Ramon, CA (US); Alexander Kaber Carroll, San Ramon, CA (US); Norman Leonard Ovens, Grand Rapids, MI (US); Sharon Ann Green, Pinellas Park, FL (US); Jennifer Ruth Cooper, San Ramon, CA (US); Michael Eric Figard, Rockford, MI (US); Sundar Murugappan, San Ramon, CA (US); Boris Soliz, San Ramon, CA (US); Masaki Merritt Akiyama, San Ramon, CA (US)

(21) Appl. No.: 15/164,591

(22) Filed: May 25, 2016

(51) Int. Cl. G08G 5/00; G07C 5/00; B64D 43/00

(52) U.S. Cl. CPC G08G 5/0047; G08G 5/0039; B64D 43/00; G07C 5/008; G08G 5/0013

(57) ABSTRACT

A system is provided that includes a controller including one or more processors disposed onboard an aircraft. The controller is configured to be operably connected to multiple subsystems on the aircraft. The controller receives operating parameters from one or more of the subsystems during a flight of the aircraft. The controller is configured to analyze the operating parameters to determine an abnormal operating condition of the aircraft. The controller is further configured to transmit a display message to a display device onboard the aircraft. The display message provides multiple responsive actions to the abnormal operating condition. The responsive actions are prioritized on the display device to indicate to the flight crew that one or more of the responsive actions are recommended over one or more other responsive actions in the display message.

### FIELD

Embodiments of the subject matter described herein relate to aircraft control systems.

### BACKGROUND

Modern aircraft include many sensors that monitor various parameters and operations of the aircraft during flight. A pilot in a flight deck of an aircraft typically receives a deluge of information, which includes data collected from the sensors, status messages from various subsystems of the aircraft (e.g., an engine subsystem, a fuel subsystem, an electronics subsystem, a flight control subsystem, or the like), and communications with other entities (e.g., other aircraft, air traffic control, an airline operation center, or the like). In addition to the sheer volume of information provided to the pilot, the information is typically not integrated to provide comprehensible insights to the pilot. For example, data parameters from different subsystems of the aircraft may be presented to the pilot on different screens at different times, which obfuscates the ability of the pilot to identify trends affecting multiple subsystems. Thus, the pilot is often tasked with sifting through raw data, checklists, crew-alerting system (CAS) messages, received communications, and other information in order to analyze and make an informed control decision for the aircraft.

Requiring the pilot to provide such manual aggregation and analyzation of information while flying the aircraft is inefficient, distracting, and can lead to inaccurate decision-making that could jeopardize the safety of the passengers and crew on the aircraft. For example, an erroneous diagnosis of a detected abnormal condition could result in the pilot pursuing a remedial action that not only fails to alleviate the abnormal condition, but also may exacerbate the problem. In one real-life example, pilots were warned of detected issues in the engine and fuel tank subsystems. The pilots, however, relying on the information at hand, misidentified the cause of the issues and applied incorrect resolution tactics which resulted in the plane losing all fuel and having to perform an emergency landing.

### BRIEF DESCRIPTION

In an embodiment, a system (e.g., an aircraft control system) includes a controller including one or more processors disposed onboard an aircraft. The controller is configured to be operably connected to multiple subsystems on the aircraft. The controller receives operating parameters from one or more of the subsystems during a flight of the aircraft. The controller is configured to analyze the operating parameters to determine an abnormal operating condition of the aircraft. The controller is further configured to transmit a display message to a display device onboard the aircraft. The display message provides multiple responsive actions to the abnormal operating condition. The responsive actions are prioritized on the display device to indicate to the flight crew that one or more of the responsive actions are recommended over one or more other responsive actions in the display message.

In another embodiment, a method (e.g., for controlling operations of an aircraft) includes receiving operating parameters at a controller that includes one or more processors disposed onboard an aircraft. The operating parameters are received from one or more subsystems of the aircraft during a flight of the aircraft. The method also includes analyzing the operating parameters to determine an abnormal operating condition of the aircraft. The method further includes transmitting a display message from the controller to a display device onboard the aircraft. The display message provides multiple responsive actions to the abnormal operating condition. The responsive actions are prioritized on the display device to indicate to the flight crew that one or more of the responsive actions are recommended over one or more other responsive actions in the display message.

In another embodiment, a system (e.g., an aircraft control system) includes a controller, a communication circuit, and a user input device. The controller includes one or more processors disposed onboard an aircraft. The controller is configured to be operably connected to multiple subsystems on the aircraft. The controller receives operating parameters from one or more of the subsystems during a flight of the aircraft. The communication circuit is configured to be disposed onboard the aircraft and operably connected to the controller. The communication circuit is configured to receive and convey off-board information to the controller during the flight. The off-board information includes at least one of weather information or airport information. The user input device is configured to be disposed onboard the aircraft and operably connected to the controller. The user input device is configured to receive user-submitted information from a flight crew of the aircraft and to convey the user-submitted information to the controller. The controller is configured to analyze the operating parameters and at least one of the off-board information or the user-submitted information to determine an abnormal operating condition of the aircraft. The controller is further configured to transmit a display message to a display device onboard the aircraft. The display message provides multiple responsive actions to the abnormal operating condition.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of an aircraft control system associated with an aircraft according to an embodiment;

FIG. 2 is a flow chart of a method for controlling operations of an aircraft according to an embodiment;

FIG. 3 illustrates a display screen of a display device of the aircraft control system according to an embodiment;

FIG. 4 illustrates an abnormal condition investigation screen that is shown on the display screen of the display device according to an embodiment;

FIG. 5 illustrates a response screen that is shown on the display screen of the display device according to an embodiment; and

FIG. 6 illustrates another response screen that is shown on the display screen of the display device according to an embodiment.

### DETAILED DESCRIPTION

As used herein, an element or step recited in the singular and proceeded with the word “a” or “an” should be understood as not excluding plural of said elements or steps, unless such exclusion is explicitly stated. Furthermore, references to “one embodiment” of the present inventive subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

As used herein, the terms “system,” “device,” or “unit” may include a hardware and/or software system that operates to perform one or more functions. For example, a unit, device, or system may include a computer processor, controller, or other logic-based device that performs operations based on instructions stored on a tangible and non-transitory computer readable storage medium, such as a computer memory. Alternatively, a unit, device, or system may include a hard-wired device that performs operations based on hard-wired logic of the device. The units, devices, or systems shown in the attached figures may represent the hardware that operates based on software or hardwired instructions, the software that directs hardware to perform the operations, or a combination thereof. The systems, devices, or units can include or represent hardware circuits or circuitry that include and/or are connected with one or more processors, such as one or computer microprocessors.

One or more embodiments of the inventive subject matter described herein provide systems and methods for controlling the movement of an aircraft during a flight and controlling internal operations of the aircraft as the aircraft moves during the flight. The systems and methods provide automated aggregation and analysis of internal information regarding the subsystems of the aircraft, external information received from an off-board source, and/or observational information received from a pilot or another member of the flight crew of the aircraft. The analysis of the internal, external, and observational information is used to detect abnormal operating conditions and present actionable insights to the flight crew of the aircraft. The actionable insights may include identification of a detected abnormal operating condition, identification of the cause and/or source of the abnormal operating condition, and/or one or more suggested actions to take in order to remedy or at least alleviate the abnormal operating condition. The suggested actions depend on the detected abnormal operating condition, and may include performing a test on or modifying the operation of one or more of the subsystems of the aircraft, modifying the movement characteristics (e.g., speed, elevation, flight path, etc.) of the aircraft, or modifying the flight schedule (e.g., changing the destination location or the arrival time). In one or more embodiments, the systems and methods described herein present the actionable insights to the flight crew with prioritization information that ranks at least some of the actionable insights to indicate that one or more actionable insights are recommended to be addressed instead of, or at least prior to, one or more other actionable insights. The systems and methods optionally may provide a coaching role for the flight crew, such that the flight crew is able to choose whether or not to follow any of the suggested actions, and, if so, which of the recommended suggested actions to take.

In one or more embodiments, an aircraft control system is provided that integrates individual subsystem information into actionable and useful synthesized insights for flight deck operations. For example, the aircraft control system provides the pilots with prioritized options and actions via system messages. The aircraft control system may gather relevant information from multiple subsystems of the aircraft, and may synthesize the onboard information from the subsystems in conjunction with contextual information provided from off-board sources (e.g., weather data, relevant traffic information, relevant airport information, or the like) and/or from the flight crew. For example, the contextual information provided from the flight crew may be observational information that is sensed by one or more members of the flight crew, such as sights, sounds, smells, vibrations, and the like experienced by the flight crew during the flight. Some contextual information may be only observable to the flight crew (and not to the mechanical instruments), such as a medical emergency regarding the health of one or more passengers or members of the flight crew. The aircraft control system is configured to analyze the collected information and present synthesized insights to the flight crew based on the analysis. The aircraft control system is configured to collaborate with the flight crew during the analysis of the information and the performance of the responsive actions. For example, the aircraft control system may prompt the pilots for confirmation and/or for the submission of observational information, which is used during the analysis to determine the abnormal operating condition of the aircraft. The synthesized insights may be presented as a set of options that are prioritized with the most likely or most recommended option notated based on a probability that such option occurs and/or will resolve a determined abnormal operating condition. The probability may be based on a review of historical data stored in a database that is accessible to one or more processors of the aircraft control system.

One or more technical effects of the aircraft control system described herein may include allowing the flight crew to make intelligent, informed decisions responsive to detected abnormal operating situations or conditions of the aircraft. For example, the integrated analysis of the onboard information from the subsystems, the off-board information from external sources, and the observational information from the flight crew, and the synthesized presentation of recommended responsive actions can allow the pilots to make efficient and effective decisions during a flight of the aircraft, which enhances the performance of the aircraft in terms of fuel consumption and safety. For example, the aircraft control system may inform pilots of upcoming abnormal situations, such as developing bad weather, and may assist the pilots in quickly and safely traversing the bad weather, such as by flying through the weather, temporarily deviating from the current flight route to bypass the weather, or diverting the flight route to an alternate route. Furthermore, the insights provided by the aircraft control system may increase the accuracy and effectiveness of the decision-making from the pilots relative to known systems that require the pilots to access multiple sources and analyze the data cognitively to reach a decision. For example, an incorrect identification of an abnormal operating condition and/or an incorrect responsive action taken to remedy the abnormal operating condition could exacerbate the abnormal operating condition or cause another abnormal operating condition. Incorrectly diagnosing a fuel leak at a right engine of the aircraft as a fuel leak at a right fuel tank, for example, could motivate the pilots to pump fuel from the left fuel tank to the right engine, exacerbating the problem as more fuel would be leaked. The aircraft control system is configured to increase safety by providing early, accurate identification of abnormal operating conditions and by recommending responsive actions that will remedy or at least alleviate the abnormal operating conditions.

In one embodiment, an abnormal operating condition may be a condition in which the aircraft operates (e.g., moves) that was not previously planned for. Examples of abnormal operating conditions include weather conditions being different (e.g., more or less precipitation, warmer or cooler temperatures, faster or slower wind speeds, different wind directions, etc.) than the weather conditions on which a flight plan previously was prepared, fuel consumption being different than the amount of fuel that was expected to be consumed, performance of a pilot, co-pilot, or other crew member deviating from the flight plan, performance of one or more subsystems of the aircraft deviating from the performance expected if the flight plan were followed or from a previous flight of the aircraft, etc.

The various embodiments are described in more detail herein with reference to the accompanying figures.

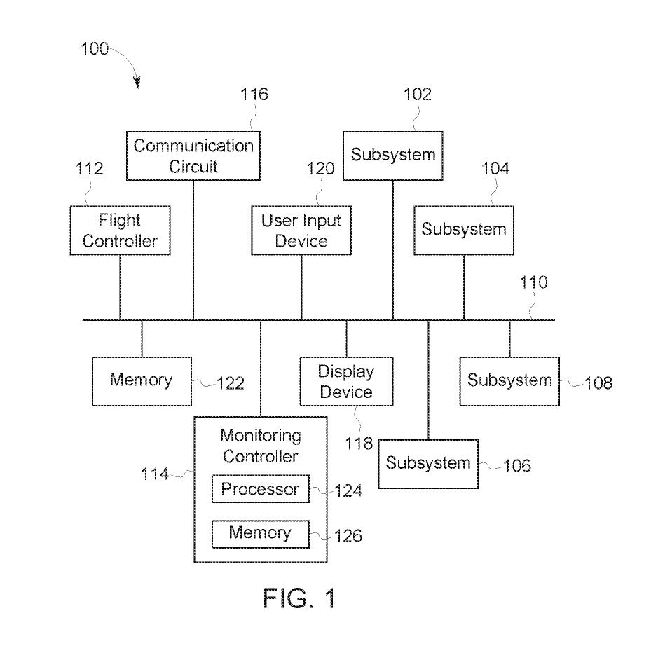

FIG. 1 is a schematic diagram of an aircraft control system 100 associated with an aircraft (not shown) according to an embodiment. Optionally, all of the components of the aircraft control system 100 may be disposed onboard the aircraft. The aircraft in one embodiment is a commercial passenger airplane, but in other embodiments the aircraft control system 100 may be associated with a military aircraft, a spacecraft, a helicopter, or the like.

The aircraft includes multiple subsystems 102, 104, 106, 108 that perform various functions on the aircraft. For example, subsystem 102 may be an engine subsystem that controls one or more propulsion engines on the aircraft and affiliated components, such as motors, generators, alternators, turbochargers, pumps, turbines, radiators, and/or the like. The engine subsystem 102 provides the thrust for the aircraft. The subsystem 104 may be a fuel subsystem that includes one or more fuel tanks on the aircraft and affiliated components. The aircraft in an embodiment includes a left fuel tank, a right fuel tank, and a trim fuel tank. The components affiliated with the fuel tanks may include various hoses and/or tubes, valves, pumps, and the like. The fuel subsystem 104 supplies fuel (e.g., gasoline, jet fuel, or the like) to the engine subsystem 102. The subsystem 106 may be a flight control subsystem that includes the wings, the tail, and affiliated components. The flight control subsystem 106 is used to control the flight characteristics of the aircraft, such as the yaw, roll, and pitch of the aircraft during the flight. For example, ailerons on the wings are controlled to adjust the roll, a rudder on the tail is controlled to adjust the yaw, and an elevator on the tail is adjusted to control the pitch. The subsystem 108 may be a landing gear subsystem that includes the landing gears and associated components. The landing gear subsystem 108 controls the deployment and retraction of the landing gears of the aircraft, and may also control the application of brakes on the wheels of the landing gears. Although not shown, the aircraft may include numerous other subsystems, such as an electrical subsystem that includes the electrical components (including interior and external lights) and connections on the aircraft, a hydraulic subsystem, a heating, ventilation, and air-conditioning (HVAC) subsystem, and the like. As used herein, reference to the subsystems 102-108 collectively may refer to the subsystems 102, 104, 106, 108 shown in FIG. 1 and one or more other subsystems of the aircraft not shown in FIG. 1.

The subsystems 102-108 each may include numerous sensors that monitor the operations of the respective subsystems 102-108. For example, the flight control subsystem 106 may include speed sensors, accelerometers, angular position sensors, and the like that monitor the orientation, position, and movement (e.g., speed and acceleration) of the aircraft during the flight as well as the orientations, positions, and movements of the various components, such as the ailerons, rudder, and elevator. The fuel subsystem 104 may include flow sensors, position sensors, and the like to monitor the usage, supply, and flow of fuel to the engines. The engine subsystem 102 may include temperature sensors, pressure sensors, position sensors, and the like to monitor, for example, the operating parameters of the oil that circulates the engines. The sensors of the various subsystems 102-108 are configured to acquire operating parameters of corresponding components of the aircraft.

The subsystems 102-108 are operably connected to a communication bus 110 of the aircraft control system 100 that allows various components of the control system 100 to communicate with one another. The communication bus 110 may include electrical conductors, such as cables, wires, bus bars and the like that provide an electrically conductive signal path between the components connected to the bus 110. Although the control system 100 in FIG. 1 is shown such that every component is directly conductively or inductively connected to the communication bus 110, in an alternative embodiment at least some of the components may be indirectly conductively or inductively connected to the communication bus 110 through another component of the control system 100.

In addition to the subsystems 102-108 and the communication bus 110, the aircraft control system 100 shown in FIG. 1 includes a flight controller 112, a monitoring controller 114, a communication circuit 116, a display device 118, a user input device 120, and a memory 122. In other embodiments, the control system 100 may include additional components, fewer components, and/or different components than the illustrated components in FIG. 1.

The flight controller 112 is configured to control the movement of the aircraft during a trip. For example, the flight controller 112 is operably connected to the engine subsystem 102 and the flight control subsystem 106 to control the operations of the subsystems 102, 106. The flight controller 112 may transmit control messages or signals to the subsystems 102, 106. For example, one control signal may command the engines of the engine subsystem 102 to increase the propulsion-generating thrust of the aircraft, and another control signal may command the rudder of the flight control subsystem 106 to pivot in order to turn or straighten the aircraft during the flight. The flight controller 112 may also be configured to transmit control signals to the fuel subsystem 104, the landing gear subsystem 108, and other subsystems on the aircraft. The flight controller 112 may include or represent one or more hardware circuits or circuitry that include and/or are connected with one or more processors, controllers, or other hardwire logic-based devices.

The display device 118 is configured to be viewable by one or more members of the flight crew of the aircraft. As used herein, the flight crew represents pilots, flight attendants, and the like. Although the description of the aircraft control system 100 herein refers primarily to a single pilot, it is recognized that multiple pilots and/or other members of the flight crew may interact with the control system 100 instead of, or in addition to, the single pilot. The display device 118 includes a display screen, which may be a liquid crystal display (LCD), a light emitting diode (LED) display, an organic light emitting diode (OLED) display, a plasma display, a cathode ray tube (CRT) display, and/or the like. The display device 118 is operably connected to the flight controller 112 and the monitoring controller 114 via the bus 110. For example, the flight controller 112 and/or the monitoring controller 114 can present information to the pilot via the display device 118, such as status information, operating parameters, warning messages (e.g., crew alerting system (CAS) messages), maps of the surrounding environment and/or upcoming segments of the route, synoptic diagrams of the aircraft and/or subsystems thereof, notifications regarding speed limits, traffic, weather reports, and the like. The display device 118 may be a computer monitor, a tablet, a mobile phone, or the like.

The user input device 120 is configured to receive user-submitted information from the flight crew and to convey the user-submitted information to the flight controller 112 and/or the monitoring controller 114. For example, the user-submitted information may include a command to adjust the thrust of the aircraft, which is conveyed to the flight controller 112 for providing an associated control signal to the engine subsystem 102. In another example, as described in more detail below, the user-submitted information may include a user selection of one or more responsive actions to take in response to a determined abnormal operating condition of the aircraft, and such user selection is conveyed to the monitoring controller 114. The user input device 120 may also be used to provide observational information to the monitoring controller 114, such as information that is sensed (e.g., seen, heard, smelled, and/or felt) by the pilot or another member of the flight crew. The user input device 120 may be or include a keyboard, a touchscreen, an electronic mouse, a microphone, a wearable device, or the like. In an example, the user input device 120 may interact with a graphical user interface (GUI) shown on the display device 118. Optionally, the user input device 120 may be a part of the display device 118, such that the input device 120 and the display device 118 are held together on a common housing or enclosure.

The communication circuit 116 is operably connected to the flight controller 112 and/or the monitoring controller 114. The communication circuit 116 may represent hardware and/or software that is used to communicate with other devices and/or systems, such as remote servers, satellites, airline operation centers, air traffic control, other aircrafts, and the like. The communication circuit 116 may include a transceiver and associated circuitry (e.g., an antenna) for wireless bi-directional communication of various types of messages, such as linking messages, command messages, reply messages, status messages, and/or the like. The communication circuit 116 may be configured to transmit messages to specific designated receivers and/or to broadcast messages indiscriminately. In an embodiment, the communication circuit 116 is configured to receive and convey off-board information to the monitoring controller 114 during a flight of the aircraft. The off-board information, as described in more detail below, may include weather information and/or airport information, such as location, extent of air traffic expected at a projected arrival time, and/or runway characteristics.

The monitoring controller 114 of the control system 100 is configured to monitor the operations of the subsystems 102-108 to detect abnormal operating conditions of the aircraft. The monitoring controller 114 receives operating parameters from one or more of the subsystems 102-108 via the bus 110 during a flight of the aircraft. The operating parameters are data parameters, such as temperature measurements, position measurements, flow rate measurements, and the like, associated with specific components of the subsystems 102-108. For example, one operating parameter may be a measured engine oil temperature in the left propulsion engine, and another operating parameter may be a measured amount of oil in the left propulsion engine. The operating parameters are measured by the sensors of the subsystems 102-108. The monitoring controller 114 includes one or more processors 124, such as a computer processor or other logic-based device that performs operations based on one or more sets of instructions (e.g., software). The instructions on which the monitoring controller 114 operates may be stored on a tangible and non-transitory (e.g., not a transient signal) computer readable storage medium, such as a local memory 126. The local memory 126 may include one or more computer hard drives, flash drives, RAM, ROM, EEPROM, and the like. Alternatively, one or more of the sets of instructions that direct operations of the monitoring controller 114 may be hard-wired into the logic of the monitoring controller 114, such that the instructions are hard-wired logic in the circuitry of the monitoring controller 114.

The aircraft control system 100 further includes a memory 122, which is a tangible and non-transitory (e.g., not a transient signal) computer readable storage medium. The memory 122 may be a system memory that is accessible by at least the monitoring controller 114 and optionally also the flight controller 112. The memory 122 may be pre-loaded with one or more databases including historical data, checklists, flight schedules, message formats and protocols, and the like. For example, the historical data may include flight records, recorded data parameters, observations, and the like from previous flights of the same and/or similar aircraft to the aircraft on which the control system 100 is disposed. The monitoring controller 114 is configured to access the historical data in the memory 122 to compare current information received with the historical data for pattern matching, identification of trends, and the like, which is used to determine an abnormal operating condition of the aircraft. The memory 122 also may be used to store data that is created during the flight of the aircraft, such as an activity log of the aircraft and/or a record of detected abnormal operating conditions and responsive actions taken to remedy the corresponding abnormal operating conditions.

In an embodiment, as described in more detail below, the monitoring controller 114 is configured to receive and analyze operating parameters from multiple subsystems 102-108 of the aircraft. In addition to operating parameters, the monitoring controller 114 may also receive off-board information received from an external source, such as weather information received from a remote weather center, an airline operation center, or the like. The off-board information may be received in message format by the communication circuit 116 and conveyed to the monitoring controller 114 via the bus 110. The monitoring controller 114 may also receive user-submitted information from the pilot or another member of the flight crew. The user-submitted information may be received by the user input device 120 and conveyed to the monitoring controller 114 via the bus 110.

The monitoring controller 114 analyzes the operating parameters, the off-board information, and/or the user-submitted information to determine a status or condition of the aircraft and the subsystems 102-108 thereof. The condition of the aircraft may be an abnormal operating condition if the analysis indicates that the aircraft is experiencing or will experience an unplanned and/or undesired situation during the flight. For example, an abnormal operating condition may be determined responsive to receiving an indication that one or more components of one of the subsystems 102-108 are not functioning properly, the aircraft is traveling towards an area of newly-developing severe weather, the flight crew reports a burning smell, or the like. A component of one of the subsystems 102-108 may not be functioning properly if an operating parameter of the component is outside of an expected or desired operating range, such as if the data parameter has exceeded a threshold value. The abnormal operating condition that is determined may provide an explanation, cause, or identification of the abnormal information or data that is received by the monitoring controller 114. The monitoring controller 114 may analyze operating parameters received from multiple subsystems 102-108, and may determine an abnormal operating condition that integrates the different parameters from the different subsystems 102-108. For example, based on operating parameters of the oil in an engine (e.g., pressure, temperature, amount, etc.) and operating parameters of fuel in a tank (e.g., amount, flow rate, etc.), the monitoring controller 114 may be configured to determine and differentiate between a fuel leak at the tank and a fuel leak at the engine. The abnormal operating condition may also be determined based on the off-board information and the user-submitted information, and by comparing the received information to historical data stored in the memory 122.

Subsequent to determining the abnormal operating condition, the monitoring controller 114 is configured to notify the flight crew by generating and transmitting a display message to the display device 118. The display message includes visual graphics, such as text, diagrams, schematics, maps, symbols, and the like, that provides information to the flight crew regarding the abnormal operating condition. The display message may include auditory alerts, vibrational alerts, flashing lights, or the like in addition to visual graphics. The display message may concurrently display operating parameters from at least two different subsystems 102-108 of the aircraft on the display device 118. The display message shown in the display device 118 may identify the abnormal operating condition, provide a cause or explanation for the abnormal operating condition, and/or provide one or more responsive actions to the abnormal operating condition. The responsive actions may be designated to remedy the abnormal operating condition or at least alleviate the abnormal operating condition. For example, one or more of the responsive actions may call for performance of a designated system test to determine an extent, cause, or identity of the abnormal operating condition, modification or adjustment of one or more flight settings (e.g., elevation, speed, flight path, etc.) or component settings (e.g., opening/closing valves, activating/deactivating pumps, etc.), communication with an air traffic controller or another off-board entity, or the like.

In an embodiment, the display message includes multiple responsive actions that are prioritized on the display device 118 to indicate to the flight crew that one or more responsive actions are recommended over one or more other responsive actions in the display message. The responsive actions are prioritized to indicate a relative likelihood of each of the responsive actions remedying the abnormal operating condition or at least identifying the abnormal operating condition. For example, the responsive actions may be ranked to indicate the most likely cause of a detected abnormal condition, such as among the alternatives of fuel leak in right fuel tank, fuel lead in right engine, sensor error, blockage in lines, or the like, with the most likely explanation denoted relative to one or more of the other alternative explanations. The responsive actions may also be ranked to indicate which of the responsive actions are most likely to provide the greatest remedial effect to the abnormal operating condition, relative to the other responsive actions. The monitoring controller 114 may access historical data in the memory 122 to determine which responsive actions to provide on the display message, as well as how to prioritize the responsive actions. For example, the historical data may provide insight as to the efficacy of certain responsive actions in remedying similar abnormal operating conditions in previous flights of the same or similar aircraft.

In response to receiving a user selection of one of the responsive actions via the user input device 120, the monitoring controller 114 may be configured to display a checklist associated with the selected responsive action on the display device 118. The checklist may represent prescribed actions, commands, and/or other information associated with the selected responsive action to be reviewed and/or performed by the flight crew. The checklist may be presented in various list formats. The checklist may also describe the effects of such actions on the aircraft and the subsystems 102-108 thereof, and/or the reasoning for pursuing the recommended course of actions.

In an embodiment, the monitoring controller 114 coaches the pilot by providing the display message with the suggested responsive actions for addressing a determined abnormal operating condition. The pilot has the ultimate decision-making ability with regards to control of the aircraft. Thus, the pilot is able to decide whether or not to accept any of the proposed responsive actions provided by the monitoring controller 114. In an embodiment, the monitoring controller 114 is not configured to control the aircraft directly, such as by sending automated control messages to the flight controller 112.

Alternatively, the monitoring controller 114 may be configured to control the aircraft. For example, in an emergency situation the monitoring controller 114 may be configured to automatically implement one or more responsive actions without receiving input by the pilot if immediate action is deemed necessary based on an emergency situation. In another example, the monitoring controller 114 may automatically implement one or more responsive actions without receiving input by the pilot in order to reduce the number of decisions required of the pilot, such as if the one or more responsive actions are relatively minor and/or the implementation of such actions not disputable. For example, the monitoring controller 114 may be configured to automatically deactivate an optional component of one of the subsystems of the aircraft, such as an air filtering device of the HVAC subsystem, in response to a determined abnormal operating condition. In an embodiment, the monitoring controller 114 may be configured to automatically implement the highest recommended responsive action to an abnormal operating condition if the flight crew has not selected one of the responsive actions during a designated time period. The designated time period may be based on a determined severity of the abnormal operating condition, such that a more serious operating condition would have a reduced time period relative to a more minor operating condition. The monitoring controller 114 may implement one or more responsive actions automatically by conveying control signals to the flight controller 112 via the bus 110. Although the monitoring controller 114 may be configured to automatically implement one or more responsive actions, the monitoring controller 114 may notify the pilot of the responsive actions that are taken, and the pilot may have the ability to override such automated responsive actions using the input device 120.

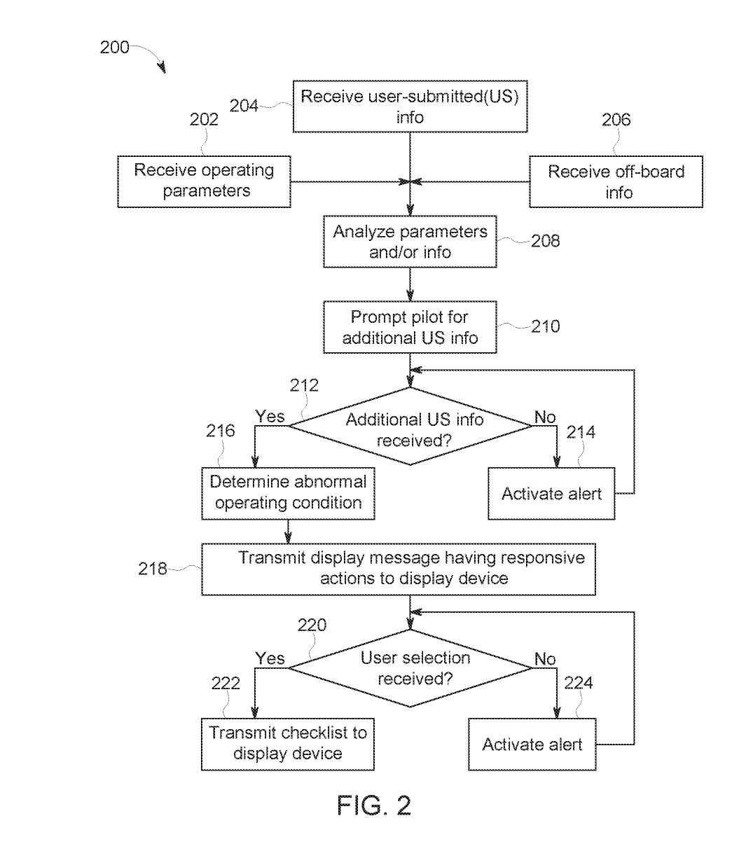

FIG. 2 is a flow chart of a method 200 for controlling operations of an aircraft according to an embodiment. The method 200 may employ or be performed by structures or aspects of various embodiments (e.g., systems and/or methods) described herein. In various embodiments, certain operations of the method 200 described below may be omitted or added, certain operations may be combined, certain operations may be performed simultaneously, certain operations may be performed concurrently, certain operations may be split into multiple operations, certain operations may be performed in a different order, or certain operations or series of operations may be re-performed in an iterative fashion. In various embodiments, portions, aspects, and/or variations of the method 200 may be able to be used as one or more algorithms to direct hardware to perform one or more operations described herein. The method 200 may be performed by the aircraft monitoring system 100 shown in FIG. 1. The monitoring controller 114 (including affiliated processors 124, memory 126, and other components) performs some or all of the steps of the method 200.

At 202, operating parameters are received at the monitoring controller 114 from one or more subsystems of the aircraft (e.g., the subsystems 102-108). The monitoring controller 114 periodically receives the operating parameters during a flight of the aircraft. The monitoring controller 114 may also receive operating parameters prior to takeoff and/or after landing. The operating parameters may be transmitted to the monitoring controller 114 via the bus 110. In an embodiment, the monitoring controller 114 is configured to integrate the operating parameters received from different subsystems of the aircraft in order to provide synthesized insights to the pilot or other member of the flight crew, instead of forcing the pilot to navigate through multiple different screens and/or directories to ascertain the operating parameters from different subsystems. The monitoring controller 114 may generate a display message that integrates the operating parameters in order to display operating parameters from different subsystems concurrently on the display device 118. As used herein, “concurrently” means that there is at least some period of time in which a first operating parameter from a first subsystem is displayed with a second operating parameter from a second subsystem, even though the total amount of time that the first operating parameter is displayed may differ from the total amount of time that the second operating parameter is displayed.

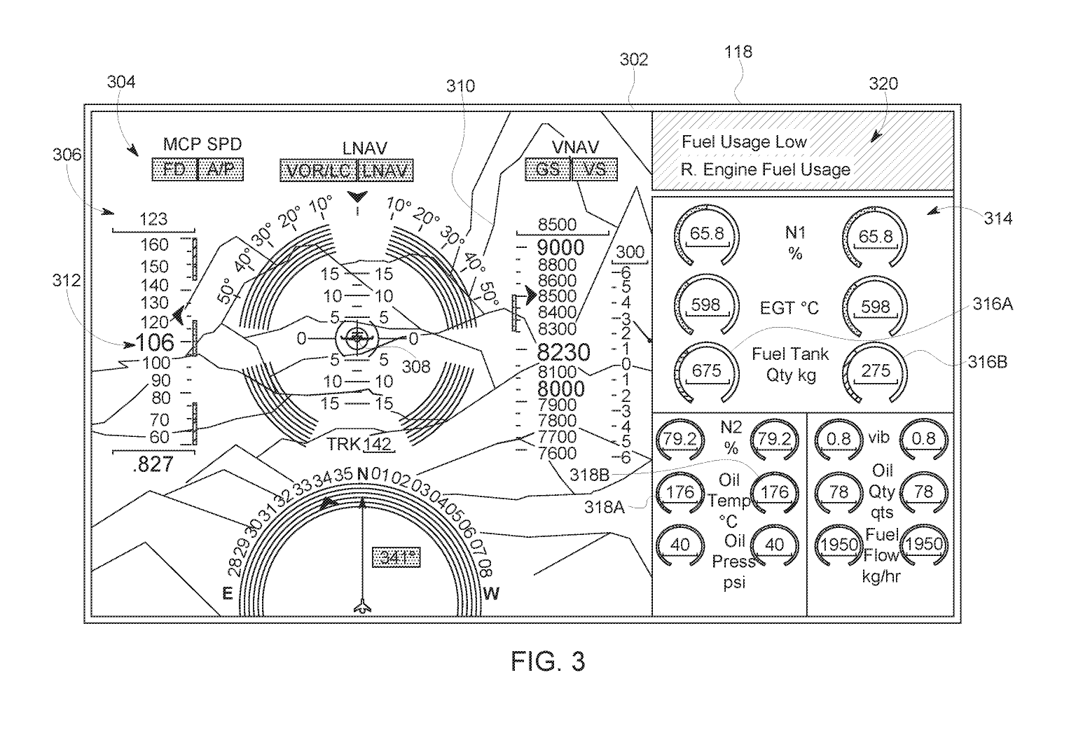

FIG. 3 illustrates a display screen 302 of the display device 118 according to an embodiment. The display screen 302 displays various graphical user interfaces (GUI) and/or computational function displays (CFD). The display screen 302 in FIG. 3 shows a flight operation screen 304 which displays information about the current flight of the aircraft. The flight operation screen 304 is based on a display message that is generated by the monitoring controller 114 and transmitted to the display device 118 for presentation on the display screen 302. The flight operation screen 304 includes a navigation window 306 that shows a graphical representation of the aircraft 308 and the surrounding environment (e.g., mountains 310). The navigation window 306 further includes overlaid flight characteristic measurements 312. The flight operation screen 304 also includes an operational information window 314 and a message window 320. The operational information window 314 includes multiple meters and/or gauges that correspond to aircraft components monitored by sensors, and display current operating parameters of the corresponding components. For example, the operational information window 314 includes a left fuel tank quantity meter 316A and a right fuel tank quantity meter 316B, as well as left and right oil temperature meters 318A, 318B, and various other meters. The fuel tank quantity meters 316A, 316B display operating parameters from the fuel subsystem, while the oil temperature meters 318A, 318B display operating parameters from the engine subsystem. Thus, the flight operation screen 304 concurrently displays operating parameters from different subsystems in order to reduce the workload on the pilot by avoiding the need to switch between multiple screens to obtain information similar to the information provided on the flight operation screen 304.

The flight operation screen 304 may also provide indicia to indicate whether the various operating parameters displayed on the screen 304 are currently in normal or abnormal levels. For example, operating parameters that are within a desired, expected, or normal range may have a different color than operating parameters that are outside of respective desired, expected, or normal ranges. The indicia may also differentiate between various severities or extents that the respective operating parameters are outside of the normal range. For example, the fuel tank quantity in the left fuel tank as indicated in meter 316A may be lower than anticipated at 675 kg, but not critically low, so the meter 316A may be displayed in a yellow color. The fuel tank quantity in the right fuel tank as indicated in meter 316B, on the other hand, may be critically low at 275 kg, so the meter 316B may be displayed in a red color. Optionally, other indicia may be used to represent severities, such as flashing lights, sounds, enlarged text or meter size, or the like.

The message window 320 of the flight operation screen 304 may display text-based messages to the pilot that indicates the status of one or more components in one or more subsystems of the aircraft. For example, in FIG. 3, the message window 320 indicates “Fuel Usage Low” to notify the pilot that the fuel usage is lower than expected or normal conditions. The message window 320 further states “R. Engine Fuel Usage” to specify that the fuel usage is particularly low in the right engine. The pilot may use the information in the message window 320 with the information presented in the navigation window 306 and the information in the operational information window 314 to make informed decisions regarding control of the aircraft without being required to navigate through multiple screens on the display device to acquire such information.

Returning now back to FIG. 2, the method 200 at 204 involves receiving user-submitted information. The user-submitted information is information submitted by the pilot or another member of the flight crew using the user input device 120 or another input device. The user input device 120 may convey the user-submitted information to the monitoring controller 114 via the bus 110. The user-submitted information may include observational information that is sensed by one or more members of the flight crew or another person onboard the aircraft. For example, the observational information may include a burning smell, a gas smell, a fuel smell, an atypical vibration, an atypical noise, an atypical trail of smoke or another substance emanating from the aircraft, or the like. The user-submitted information may also include confirmations and/or selections based on prompts provided by the monitoring controller 114 on the display device. Thus, the aircraft control system 100 in an embodiment is configured to collaborate with the flight crew during operation.

At 206, off-board information is received by the monitoring controller 114. The off-board information is initially received by the communication circuit 116 and conveyed to the monitoring controller 114 via the bus 110. The off-board information may include various types of information, such as weather information at various times or locations along a schedule flight (e.g., a weather report corresponding to an upcoming segment of the flight), airport information (e.g., location, runway lengths, orientations for approach to runways, etc.), or the like. The airport information may include traffic information at a designated airport, which may affect gate clearance for landing the aircraft at a designated arrival time. For example, if there are multiple aircraft scheduled to arrive at the airport in the same time period as the aircraft that includes the control system 100, the aircraft may not be granted gate clearance right away, requiring the aircraft to embark on a holding pattern until such clearance is granted. Flying in a holding pattern is typically undesirable because the aircraft consumes additional fuel and the passengers and crew are delayed from an anticipated arrival time. Although information regarding a planned destination airport may be stored onboard, the communication circuit 116 may receive off-board information about other airports to which the aircraft may divert towards in the case of an emergency.

At 208, the monitoring controller 114 is configured to analyze the operating parameters, the user-submitted information, and the off-board information in order to provide synthesized insights for the pilot. Although the monitoring controller 114 is configured to analyze all three of the operating parameters, user-submitted information, and off-board information, the monitoring controller 114 may not receive all three types of information during each iteration of the method 200. For example, the monitoring controller 114 may analyze the operating parameters from the subsystems alone, may analyze the operating parameters with the user-submitted information alone, may analyze the operating parameters with the off-board information alone, or may analyze the user-submitted information with the off-board information alone. Thus, not all of the steps 202, 204, and 206 may be performed for each iteration of the method 200.

Optionally, at 210 the pilot or another member of the flight crew is prompted for additional user-submitted information. The monitoring controller 114 may ask the pilot for additional observational information using the display device, and the pilot may respond using the user input device. The monitoring controller 114 may ask directed, specific questions and/or broad, open-ended questions. It is recognized that the user-submitted information that is requested at 210 would not be “additional” if no user-submitted information had previously been received at 204.

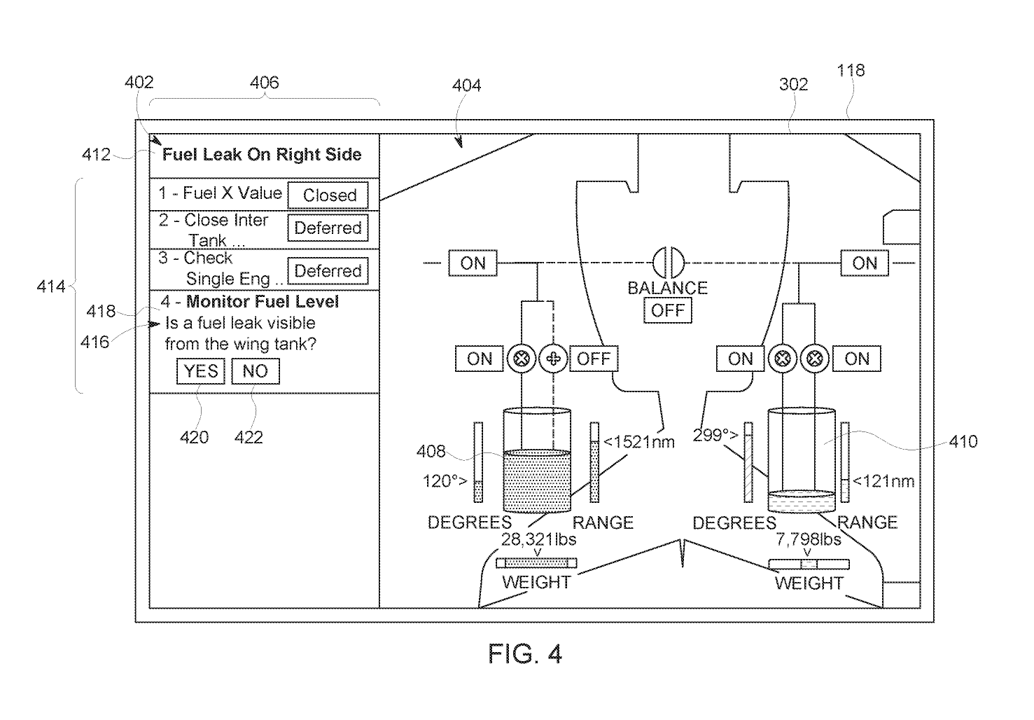

FIG. 4 illustrates the display screen 302 of the display device 118 according to an embodiment. The display screen 302 shows an abnormal condition investigation screen 402. The abnormal condition investigation screen 402 is displayed after an analysis of the operating parameters, user-submitted information, and/or off-board information indicates an abnormal situation, but an identification or cause of the abnormal operating condition is under investigation. The abnormal condition investigation screen 402 includes a synopsis window 404 and a communication window 406. The synopsis window 404 in the illustrated embodiment shows a synoptic diagram of the fuel subsystem of the aircraft, which includes a left fuel tank 408 and a right fuel tank 410. The synoptic diagram is overlaid with various data regarding the current operating parameters of the fuel tanks 408, 410 and associated components. The communication window 406 includes a title bar 412 that states a detected abnormal situation, which is a fuel leak on the right side. Under the title bar 412 is an investigation list 414 that walks the pilot through various steps in order to diagnose the identification or cause of the abnormal operating condition. For example, the investigation list 414 may include one or more system tests, or steps thereof, to be performed on one or more subsystems 102-108 of the aircraft. The investigation list 414 includes a user prompt 416 within an item box 418 denoted “4—Monitor Fuel Level.” The user prompt 416 asks, “Is a fuel leak visible from the wing tank?” Below the prompt 416 is a “yes” button 420 adjacent to a “no” button 422. The pilot may answer the question by selecting one of the buttons 420, 422 using the user input device 120. For example, the pilot may select one of the buttons 420, 422 using an electronic cursor, a physical key or button on a keyboard, a touchscreen, a voice command using speech recognition software, or the like.

In an embodiment, the monitoring controller 114 generates the user prompt 416 to request that the pilot or another crew member provide specific observational information. In this example, whether or not a fuel leak is visible from a wing tank may be used to determine the source, cause, and/or identity of the abnormal operating condition. For example, a fuel leak that is visible from the right wing may indicate that the source of the fuel leak is in or around the wing tank, instead of in or around the engine. Thus, the aircraft control system 100 collaborates with the flight crew in order to investigate and determine the abnormal operating condition.

Referring now back to FIG. 2, the method 200 at 212 determines whether additional user-submitted information has been received. If the additional user-submitted information has not been received, flow of the method 200 continues to 214 and an alert is activated. For example, an alert may be activated if no response is provided by the pilot for a given period of time after the pilot is prompted for information, such as 30 seconds or one minute. The alert may consist of an audible noise and/or flashing light on or around the display device 118. If, on the other hand, the pilot has submitted the requested additional information, then flow proceeds to 216.

At 216, an abnormal operating condition is determined by the monitoring controller 114 based on the analysis of the information received. For example, the monitoring controller 114 analyzes the operating parameters, the observational information from the flight crew, and/or the off-board information and may compare such information to historical data stored in the memory 122. The monitoring controller 114 may compare trends, patterns, values, and the like between the current information and the historical data to determine the abnormal operating condition. The memory 122 may store a plurality of known abnormal operating conditions with associated corresponding operating parameters (and other information) in one or more databases. Thus, the monitoring controller 114 may match the measured operating parameters, observational information, and off-board information to the stored data in the database to match the measured data with one of the abnormal operating conditions stored in the memory 122. In the example shown in FIG. 4, the abnormal operating condition may be determined to be a fuel leak in the right fuel tank, depending on the information received. In another example that is based on weather information, an abnormal operating condition may be that the aircraft is on course to fly into a developing thunderstorm.

At 218, the monitoring controller 114 is configured to generate and transmit a display message to the display device 118. The display device 118 presents the display message to the pilot. The display message includes at least one responsive action that corresponds to the abnormal operating condition, such that the responsive actions are configured to at least partially remedy the abnormal operating condition. The responsive actions are presented as selectable options to the pilot.

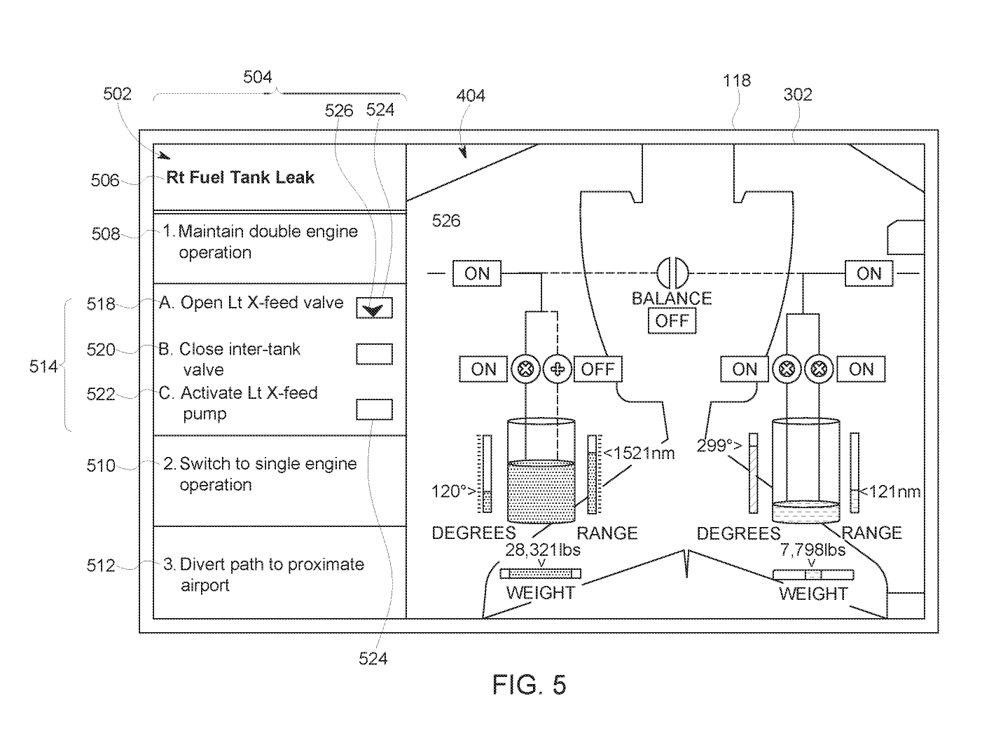

FIG. 5 illustrates a response screen 502 that is shown on the display screen 302 of the display device 118 according to an embodiment. The response screen 502 includes the synopsis window 404 shown in FIG. 4 and an information panel 504. The information panel 504 includes a title bar 506 that identifies the abnormal operating condition. The abnormal operating condition is identified in FIG. 5 as a right fuel tank leak. Below the title bar 506 is a list of multiple responsive actions based on the specific abnormal operating condition. The responsive actions in the illustrated embodiment include a first responsive action 508 to “maintain double engine operation,” a second responsive action 510 to “switch to single engine operation,” and a third responsive action 512 to “divert path to proximate airport.” Since a leak in the right fuel tank has been determined by the monitoring controller 114, the option to maintain double engine operation involves distributing fuel from the left fuel tank to both right and left engines to remedy, or at least alleviate, the issues caused by the fuel leak. The option to switch to single engine operation involves deactivating one of the engines, such as the right engine that is supplied fuel from the leaking right fuel tank. The third option to divert the flight path to a proximate airport means that the aircraft will change the scheduled route and destination airport and instead fly to a more proximate airport to land. The third option may be a more drastic option than the other two options presented, but may be necessary in an emergency. The responsive actions 508-512 may be stored in the memory 122 and accessed by the monitoring controller 114. Various responsive actions may be associated with corresponding abnormal operating conditions in one or more databases in the memory 122. The memory 122 may also include rule-based instructions. For example, the responsive actions to an abnormal operating condition that involves the aircraft flying towards bad weather may be rule-based and dependent on the type of weather (e.g., tornado, hurricane, rain, snow) and the severity. The responsive screen 502 presents the responsive actions 508-512 as selectable options for the pilot to select using the user input device 120.

In an embodiment, the responsive actions 508-512 are prioritized in the display message from the monitoring controller 114 such that the responsive actions 508-512 are ranked on the display device 118. The responsive actions 508-512 are prioritized to indicate that one or more of the responsive actions 508-512 are recommended over one or more other responsive actions 508-512 in the display message presented to the pilot. For example, the higher recommended responsive actions (e.g., action 508) may be shown on the response screen 502 higher (e.g., more proximate to the title bar 506) than lower recommended responsive actions (e.g., action 512). Thus, the monitoring controller 114 suggests that the pilot pursue the first responsive action 508 to maintain double engine operation, and the second-ranked option is to pursue to the second option 510 to switch to single engine operation. The third responsive action 512 is ranked lower than the other two actions 508, 510, such that the monitoring controller 114 recommends pursuing the third option 512 only after pursing the first two actions 508, 510. In other embodiments, the response screen 502 may identify the prioritization of the responsive actions by showing higher-ranked responsive actions as having a larger size, a different color, and/or with different indicia (e.g., symbols, font styles, or the like) than lower-ranked responsive actions. In another embodiment, the responsive actions may be shown on different screens, such that the higher-ranked responsive actions are displayed prior to lower-ranked responsive actions.

The monitoring controller 114 may access the memory 122 to determine the prioritization of the responsive actions in the display message that is displayed in the response screen 502. For example, the memory 122 may include rule-based prioritization. The stored abnormal operating conditions may have various assigned severity levels, and the stored responsive actions may also be assigned with specific severity levels. Thus, depending on the severity of the determined abnormal operating condition, the responsive actions may be prioritized such that the responsive actions of a similar severity level are ranked higher than the responsive actions that are more severe or less severe than the determined abnormal operating condition. For example, responsive to determining that an abnormal operating condition is a right fuel tank leak in which the right fuel tank is empty and the left fuel tank, due to the leak, is critically low on fuel, the highest recommended responsive action may be to divert the flight path to land at the closest airport since the situation is more severe than the situation described above.

Referring now back to FIG. 2, at 220 a determination is made whether a user selection has been received regarding the selection of one of the responsive actions of the display message. If no user selection has been received after a designated period, flow of the method 200 proceeds to 224 and an alert is activated to notify the pilot to make a selection. Once a user selection of one of the responsive actions is received, flow continues to 222 and the monitoring controller transmits a checklist to the display device 118. The checklist is associated with the selected one of the responsive actions.

Referring now back to FIG. 5, the response screen 502 displays a checklist 514 that is associated with the first responsive action 508 to maintain double engine operation. The checklist 514 is presented in a detail window 516 located under the first responsive action 508 between the first responsive action 508 and the second responsive action 510. The checklist 514 may be displayed in response to the pilot selecting the first responsive action 508 using the user input device 120. The checklist 514 includes multiple items or tasks that correspond to the selected responsive action 508. For example, the checklist 514 in the illustrated embodiment includes a first task 518 to open a left cross-feed valve, a second task 520 to close an inter-tank valve, and a third task 522 to activate a left cross-feed pump. The tasks 518-522 are configured to carry out the responsive action 508 of maintaining double engine operation while remedying issues caused by the fuel leak. The tasks 518-522 may or may not be arranged in an order representative of a desired chronological sequence of events. The task 518 to open a left cross-feed valve means that a valve is opened that allows fuel from the left fuel tank to flow directly to the right engine, instead of flowing to the right fuel tank. The task 520 to close an inter-tank valve means that a valve is closed to prevent the flow of fuel between the two fuel tanks. The task 522 to activate a left cross-feed pump means that a pump is activated which pumps fuel from the left fuel tank to the right engine (through the left cross-feed valve).

The checklist 514 may be stored in the memory 122 in a database that associates various checklists with corresponding responsive actions. Therefore, upon receiving the user selection of the responsive action 508, the monitoring controller 114 is configured to access the memory 122 to retrieve the checklist 514 that is affiliated with the selected responsive action 508. The monitoring controller 114 then transmits the checklist 514 to the display device 118, such as in a display message, for presentation to the pilot. In an embodiment, the checklist 514 includes completion boxes 524 adjacent to each of the tasks 518-522. The completion boxes 524 are configured to provide indicia 526 to indicate whether the tasks 518-522 have been completed. In the illustrated embodiment, the indicia 526 is a checkmark, but in other embodiments the indicia 526 may be a specific color, a word such as “completed,” an “X” mark, or the like. The response screen 502 indicates that the first task 518 to open the left cross-feed valve has been completed but the other two tasks 520, 522 of the checklist 514 are not completed. The monitoring controller 114 may automatically update the completion boxes 524 to indicate which tasks 518-522 are completed. Optionally, the pilot may have the ability to manipulate the completion boxes 524. Although not shown in FIG. 5, the checklist 514 for carrying out the responsive action 508 of maintaining double engine operation may include more than three tasks.

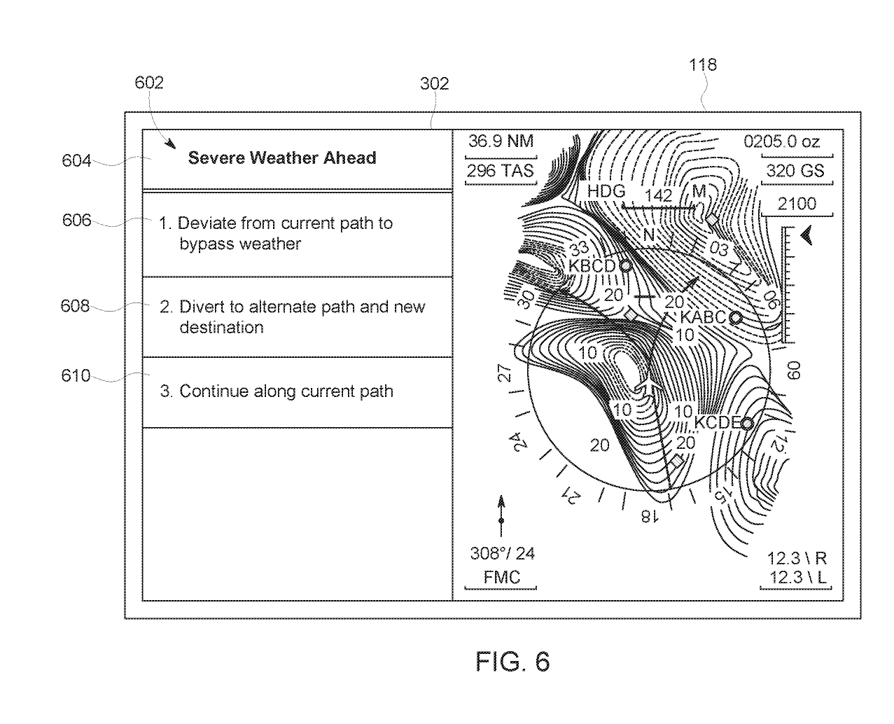

FIG. 6 illustrates another response screen 602 that is shown on the display screen 302 of the display device 118 according to an embodiment. In an embodiment, the monitoring controller 114 may analyze the received information and determine that the aircraft along the prescribed flight path will experience severe weather during an upcoming segment of the flight. The severe weather, or at least the severity of the weather, was not anticipated. Thus, the abnormal operating condition is severe weather in the flight path. The severe weather may be a thunderstorm, a tornado, a hurricane, hail, or the like. In the response screen 602, the title bar 604 indicates that the abnormal operating condition is severe weather ahead. The monitoring controller 114 is configured to analyze weather information received off-board sources, operating parameters received from relevant subsystems (e.g., GPS location data, barometer measurements, etc.), and/or observational information received from the flight crew (e.g., an observation that the weather appears to be less severe to the west), to identify the type and severity of the weather. The severity of the weather may account for such characteristics as the size of the affected region of the sky and the location of the affect region in terms of elevation, planar coordinates, or the like.

The response screen 602 includes multiple responsive actions listed below the title bar 604. A first responsive action 606 provides the option to deviate temporarily from the prescribed flight path to bypass the region of the sky affected by the severe weather. A second responsive action 608 gives the option to divert to an alternate flight path towards a new destination airport. A third responsive action 610 provides the option to continue along the current flight path through the severe weather. The responsive actions 606-610 are prioritized such that the first responsive action 606 to deviate temporarily from the prescribed flight path is recommended over the other two responsive actions 608, 610, and the second responsive action 608 to divert to an alternate path is recommended over the third responsive action 610 to continue along the current path. The prioritization may be based on a determined threat level that the severe weather poses on the safety of the aircraft as well as the benefits and drawbacks of each of the responsive actions 606 individually. For example, diverting the aircraft to fly around the weather may be the recommended option because the weather poses at least a noticeable threat to the safety of the aircraft and/or diverting the aircraft to bypass the bad weather may be relatively simple to perform without expending a significant amount of extra time or fuel in the process.

Since the responsive actions 606-610 are presented to the pilot as selectable options, the ultimate decision-making ability is retained with the pilot. Thus, the pilot may choose to select one of the other recommended responsive actions 608, 610 instead of the highest recommended action 606. In an embodiment, assuming that the pilot selects the second responsive action 608 to divert the aircraft to an alternate path towards a new destination airport, the monitoring controller 114 may then access information about various airports proximate to the location of the aircraft in order to provide recommendations for the new destination airport. The airport information may be stored in the memory 122 and/or may be received from an off-board source. For example, the monitoring controller 114 may broadcast a message using the communication circuit 116 requesting proximate airports to send information about the airports in a message format interpretable by the communication circuit 116. In addition to basic identification and location information of each of the proximate airports, the airport information may that is received may include data regarding the runways, such as the number, sizes, and orientations of the runways. The airport information may also include information about traffic, such as whether any runways and/or gates are available at a projected arrival time of the aircraft at the corresponding airport. Based on the airport information, the monitoring controller 114 is configured to determine which airports would be able to physically accommodate the aircraft. The monitoring controller 114 may also rank or prioritize the airports that are able to accommodate aircraft, such as by weighing such factors as availability or clearance at the airport at a projected arrival time, distance from the current location of the aircraft to the airport, and the like.

In another embodiment separate from the embodiment described above with reference to FIG. 6, the aircraft traveling towards a prescribed destination airport may receive off-board information about the airport. The monitoring controller 114 analyzes the received information and determines that the destination airport will not have clearance for the aircraft to land if the aircraft arrives at the projected arrival time. The lack of clearance at the destination airport may be considered an abnormal operating condition, since the flight crew anticipated being granted clearance to land upon arrival. Furthermore, if the aircraft arrives at the destination airport and is not granted clearance to land, the aircraft would be forced to fly in a holding pattern which consumes fuel. The monitoring controller 114 may generate a display message for presentation on the display device 118. The display message has multiple responsive actions for remedying, or at least alleviating, the issues caused by the traffic or congestion at the destination airport. For example, a first responsive action may be to continue traveling along the current flight path at the current speed profile (e.g., which may include designated speeds and accelerations as a function of time or location of the aircraft during the flight). Another responsive action may be to deviate from the current speed profile to an updated speed profile that has reduced speeds relative to the current speed profile. For example, reducing the speed of the aircraft causes the aircraft to arrive at the airport at a later time than the original arrival time, which may reduce the amount of time in the holding pattern if not eliminate the need to embark on a holding pattern. Thus, fuel may be saved by traveling slower towards the destination airport. Yet another responsive action may be to deviate from the current flight path to an updated flight path that may reduce fuel consumption relative to the current flight path. For example, the updated flight path may direct the aircraft to fly higher or lower than the current flight path or into a jet stream in order to reduce fuel consumption. The fuel conservation may help to offset the fuel wasted during the upcoming anticipated holding pattern at the destination airport.

In the embodiments and examples described above, the particular abnormal operating conditions, responsive actions, and checklist tasks are merely examples and are not intended to limit the scope of potential abnormal operating conditions, responsive actions, and checklist tasks that may be provided by the aircraft control system 100.

In an embodiment, a system (e.g., an aircraft control system) includes a controller including one or more processors disposed onboard an aircraft. The controller is configured to be operably connected to multiple subsystems on the aircraft. The controller receives operating parameters from one or more of the subsystems during a flight of the aircraft. The controller is configured to analyze the operating parameters to determine an abnormal operating condition of the aircraft. The controller is further configured to transmit a display message to a display device onboard the aircraft. The display message provides multiple responsive actions to the abnormal operating condition. The responsive actions are prioritized on the display device to indicate to the flight crew that one or more of the responsive actions are recommended over one or more other responsive actions in the display message.

Optionally, the controller is configured to integrate operating parameters received from at least two of the multiple subsystems in the display message to concurrently display the operating parameters from the at least two subsystems on the display device.

Optionally, the system further includes a communication circuit operably connected to the controller. The controller is configured to receive off-board information via the communication circuit during the flight. The off-board information includes at least one of weather information or airport information.

Optionally, the off-board information includes weather information regarding an upcoming segment of the flight. Responsive to the weather information indicating weather of at least a designated threshold severity to be encountered during the upcoming segment of the flight, the controller is configured to generate a display message having responsive actions that include one or more of continue traveling along a current flight path, deviate from the current flight path to travel around the weather, or divert the aircraft to a different destination airport than a prescribed destination airport.

Optionally, the off-board information includes airport information. Responsive to the airport information indicating a lack of clearance for the aircraft to land at a destination airport at a projected arrival time, the controller is configured to generate a display message having responsive actions that include one or more of continue traveling along current flight path at current speed profile, deviate from current speed profile to an updated speed profile having reduced speeds relative to the current speed profile, or deviate from current flight path to reduce fuel consumption.

Optionally, the system further includes a user input device onboard the aircraft operably connected to the controller. The controller is configured to receive user-submitted information from the flight crew via the user input device.

Optionally, the user-submitted information is a user selection indicating a selected one of the responsive actions via the user input device. Responsive to receiving the user selection, the controller is configured to transmit a checklist to the display device. The checklist is associated with the selected one of the responsive actions.

Optionally, the user-submitted information includes observational information that is sensed by one or more members of the flight crew. The controller is configured to analyze the observational information with the operating parameters to determine the abnormal operating condition.

Optionally, the subsystems on the aircraft include one or more of an engine subsystem, a fuel subsystem, a flight control subsystem, a heating, ventilation, and air-conditioning (HVAC) subsystem, a hydraulic subsystem, an electrical subsystem, or a landing gear subsystem.

Optionally, the system further includes a memory electrically connected to the controller. The memory is configured to store a plurality of abnormal operating conditions associated with corresponding operating parameters. The controller is configured to access the memory to determine the abnormal operating condition based on the operating parameters received from the one or more subsystems during the flight. The controller is further configured to access the memory to prioritize the responsive actions in the display message.

In another embodiment, a method (e.g., for controlling operations of an aircraft) includes receiving operating parameters at a controller that includes one or more processors disposed onboard an aircraft. The operating parameters are received from one or more subsystems of the aircraft during a flight of the aircraft. The method also includes analyzing the operating parameters to determine an abnormal operating condition of the aircraft. The method further includes transmitting a display message from the controller to a display device onboard the aircraft. The display message provides multiple responsive actions to the abnormal operating condition. The responsive actions are prioritized on the display device to indicate to the flight crew that one or more of the responsive actions are recommended over one or more other responsive actions in the display message.

Optionally, the responsive actions in the display message are prioritized to indicate a relative likelihood of each of the responsive actions at least one of identifying or remedying the abnormal operating condition of the aircraft.

Optionally, the display message includes operating parameters received from at least two of the multiple subsystems on the aircraft that are displayed concurrently on the display device.

Optionally, the responsive actions are arranged on the display device such that higher recommended responsive actions are shown at least one of above, prior to, in a larger size, in a different color, or with a different indicia relative to lower recommended responsive actions.

Optionally, the method further includes receiving a user selection of a selected one of the responsive actions via a user input device onboard the aircraft. Responsive to receiving the user selection, the method includes transmitting a checklist to the display device. The checklist is associated with the selected one of the responsive actions.

Optionally, the method further includes receiving observational information from the flight crew via a user input device onboard the aircraft. The observational information is analyzed with the operating parameters received from the one or more subsystems to determine the abnormal operating condition.

In another embodiment, a system (e.g., an aircraft control system) includes a controller, a communication circuit, and a user input device. The controller includes one or more processors disposed onboard an aircraft. The controller is configured to be operably connected to multiple subsystems on the aircraft. The controller receives operating parameters from one or more of the subsystems during a flight of the aircraft. The communication circuit is configured to be disposed onboard the aircraft and operably connected to the controller. The communication circuit is configured to receive and convey off-board information to the controller during the flight. The off-board information includes at least one of weather information or airport information. The user input device is configured to be disposed onboard the aircraft and operably connected to the controller. The user input device is configured to receive user-submitted information from a flight crew of the aircraft and to convey the user-submitted information to the controller. The controller is configured to analyze the operating parameters and at least one of the off-board information or the user-submitted information to determine an abnormal operating condition of the aircraft. The controller is further configured to transmit a display message to a display device onboard the aircraft. The display message provides multiple responsive actions to the abnormal operating condition.

Optionally, the off-board information includes weather information regarding an upcoming segment of the flight. Responsive to the weather information indicating weather of at least a designated threshold severity to be encountered during the upcoming segment of the flight, the controller is configured to generate a display message having at least one responsive action that includes one or more of continue traveling along a current flight path, deviate from the current flight path to travel around the weather, or divert the aircraft to a different destination airport than a prescribed destination airport.

Optionally, the user-submitted information includes observational information that is sensed by the flight crew. The controller is configured to prompt the flight crew to provide the observational information. The controller is further configured to analyze the observational information with at least the operating parameters to determine the abnormal operating condition.

Optionally, the user-submitted information includes a user selection indicating a selected responsive action of the at least one responsive action via the user input device. Responsive to receiving the user selection, the controller is configured to transmit a checklist to the display device. The checklist is associated with the selected responsive action.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, controllers or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” or “an embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A system comprising:
a controller including one or more processors disposed onboard an aircraft, the controller configured to be operably connected to multiple subsystems on the aircraft, the controller receiving operating parameters from one or more of the subsystems during a flight of the aircraft, the controller configured to analyze the operating parameters to determine an abnormal operating condition of the aircraft, the controller further configured to transmit a display message to a display device onboard the aircraft, the display message providing multiple responsive actions to the abnormal operating condition, the responsive actions being prioritized on the display device to indicate to the flight crew that one or more of the responsive actions are recommended over one or more other responsive actions in the display message.

2. The system of claim 1, wherein the controller is configured to integrate operating parameters received from at least two of the multiple subsystems in the display message to concurrently display the operating parameters from the at least two subsystems on the display device.

3. The system of claim 1, further comprising a communication circuit operably connected to the controller, the controller configured to receive off-board information via the communication circuit during the flight, the off-board information including at least one of weather information or airport information.

4. The system of claim 3, wherein the off-board information includes weather information regarding an upcoming segment of the flight, and, responsive to the weather information indicating weather of at least a designated threshold severity to be encountered during the upcoming segment of the flight, the controller is configured to generate a display message having responsive actions that include one or more of continue traveling along a current flight path, deviate from the current flight path to travel around the weather, or divert the aircraft to a different destination airport than a prescribed destination airport.

5. The system of claim 3, wherein the off-board information includes airport information, and, responsive to the airport information indicating a lack of clearance for the aircraft to land at a destination airport at a projected arrival time, the controller is configured to generate a display message having responsive actions that include one or more of continue traveling along current flight path at current speed profile, deviate from current speed profile to an updated speed profile having reduced speeds relative to the current speed profile, or deviate from current flight path to reduce fuel consumption.

6. The system of claim 1, further comprising a user input device onboard the aircraft operably connected to the controller, the controller configured to receive user-submitted information from the flight crew via the user input device.

7. The system of claim 6, wherein the user-submitted information is a user selection indicating a selected one of the responsive actions via the user input device, wherein, responsive to receiving the user selection, the controller is configured to transmit a checklist to the display device, the checklist being associated with the selected one of the responsive actions.

8. The system of claim 6, wherein the user-submitted information includes observational information that is sensed by one or more members of the flight crew, the controller configured to analyze the observational information with the operating parameters to determine the abnormal operating condition.

9. The system of claim 1, wherein the subsystems on the aircraft include one or more of an engine subsystem, a fuel subsystem, a flight control subsystem, a heating, ventilation, and air-conditioning (HVAC) subsystem, a hydraulic subsystem, an electrical subsystem, or a landing gear subsystem.

10. The system of claim 1, further comprising a memory electrically connected to the controller, the memory configured to store a plurality of abnormal operating conditions associated with corresponding operating parameters, the controller configured to access the memory to determine the abnormal operating condition based on the operating parameters received from the one or more subsystems during the flight, the controller further configured to access the memory to prioritize the responsive actions in the display message.

11. A method comprising:
receiving operating parameters at a controller that includes one or more processors disposed onboard an aircraft, the operating parameters received from one or more subsystems of the aircraft during a flight of the aircraft;
analyzing the operating parameters to determine an abnormal operating condition of the aircraft; and
transmitting a display message from the controller to a display device onboard the aircraft, the display message providing multiple responsive actions to the abnormal operating condition, the responsive actions being prioritized on the display device to indicate to the flight crew that one or more of the responsive actions are recommended over one or more other responsive actions in the display message.

12. The method of claim 11, wherein the responsive actions in the display message are prioritized to indicate a relative likelihood of each of the responsive actions at least one of identifying or remedying the abnormal operating condition of the aircraft.

13. The method of claim 11, wherein the display message includes operating parameters received from at least two of the multiple subsystems on the aircraft that are displayed concurrently on the display device.

14. The method of claim 11, wherein the responsive actions are arranged on the display device such that higher recommended responsive actions are shown at least one of above, prior to, in a larger size, in a different color, or with a different indicia relative to lower recommended responsive actions.

15. The method of claim 11, further comprising receiving a user selection of a selected one of the responsive actions via a user input device onboard the aircraft, and, responsive to receiving the user selection, transmitting a checklist to the display device, the checklist being associated with the selected one of the responsive actions.

16. The method of claim 11, further comprising receiving observational information from the flight crew via a user input device onboard the aircraft, wherein the observational information is analyzed with the operating parameters received from the one or more subsystems to determine the abnormal operating condition.

17. A system comprising:
a controller including one or more processors disposed onboard an aircraft, the controller configured to be operably connected to multiple subsystems on the aircraft, the controller receiving operating parameters from one or more of the subsystems during a flight of the aircraft;
a communication circuit configured to be disposed onboard the aircraft and operably connected to the controller, the communication circuit configured to receive and convey off-board information to the controller during the flight, the off-board information including at least one of weather information or airport information; and
a user input device configured to be disposed onboard the aircraft and operably connected to the controller, the user input device configured to receive user-submitted information from a flight crew of the aircraft and to convey the user-submitted information to the controller,
wherein the controller is configured to analyze the operating parameters and at least one of the off-board information or the user-submitted information to determine an abnormal operating condition of the aircraft, the controller further configured to transmit a display message to a display device onboard the aircraft, the display message providing at least one responsive action to the abnormal operating condition.

18. The system of claim 17, wherein the off-board information includes weather information regarding an upcoming segment of the flight, and, responsive to the weather information indicating weather of at least a designated threshold severity to be encountered during the upcoming segment of the flight, the controller is configured to generate a display message having at least one responsive action that includes one or more of continue traveling along a current flight path, deviate from the current flight path to travel around the weather, or divert the aircraft to a different destination airport than a prescribed destination airport.

19. The system of claim 17, wherein the user-submitted information includes observational information that is sensed by the flight crew, the controller configured to prompt the flight crew to provide the observational information, the controller further configured to analyze the observational information with at least the operating parameters to determine the abnormal operating condition.

20. The system of claim 17, wherein the user-submitted information includes a user selection indicating a selected responsive action of the at least one responsive action via the user input device, wherein, responsive to receiving the user selection, the controller is configured to transmit a checklist to the display device, the checklist being associated with the selected responsive action.
